(19) United States
(12) Patent Application Publication
(10) Pub. No.: US 2008/0123110 A1
(43) Pub. Date: May 29, 2008

(54) MULTIFACETED DIGITIZER ADAPTER

(75) Inventors: Brian R. Dickinson, Grass Lake, MI (US); Matthew J. Mahaffy, Tipton, MI (US)

Correspondence Address: GIFFORD, KRASS, SPRINKLE,;ANDERSON & CITKOWSKI, P.C., P.O. BOX 7021, TROY, MI, 48007-7021, US

(73) Assignee: Toyota Engineering & Manufacturing North America, Inc., Erlanger, KY (US)

(21) Appl. No.: 11/533,545

(22) Filed: Sep. 20, 2006

(51) Int. Cl. G01B 11/14

(52) U.S. Cl. 356/620

(57) ABSTRACT

A method of scanning an object includes the steps of: providing a digitizer adapter having at least three markers disposed along a target surface thereof, wherein the digitizer adapter includes a spherical member disposed a predetermined distance at its center point to each of the at least three markers; securing the adapter along an outer surface of the object; creating a plurality of digital images of the object; extracting the coordinates of the at least three markers from the image using photogrammetry; calculating the coordinates of the center point of the spherical member based on the coordinates of the at least three markers; generating surface data by scanning the outer surface of the object and the spherical member; calculating the coordinates of the center point of the spherical member based on at least three points from the surface data of the spherical member; and aligning the center point coordinates to facilitate combining the data from the photogrammetric and surface scan processes.

### BACKGROUND OF THE INVENTION

1. Field of the Invention

The invention relates to tools used in the field of object measurement. More particularly, the invention relates to a multifaceted digitizer adapter that provides an adjustable target mountable to an object to be measured, which facilitates combining surface scan data and photogrammetry data taken of the object.

2. Description of the Related Art

In the field of object measurement, three dimensional (3D) scanners are used to measure and collect point data related to the shape of an object. The collected data or “point cloud” can then be used to reconstruct by extrapolation a 3D model of the object. The 3D model may be used in a wide variety of applications, such as in a manufacturing setting for taking quality control measurements of manufactured parts and comparing the measurements to the theoretical CAD data. There are two general types or classes of 3D scanners: contact and non-contact.

Contact 3D scanners take point measurements of the object though physical touch using a probe end mounted to an articulating arm. A coordinate measuring machine (or CMM) is a common example of a contact 3D scanner. Contact 3D scanners, however, do pose some disadvantages. One disadvantage is that it requires contact with the object being scanned, which presents the potential to modify or damage it. This is significant when scanning pliable, delicate or valuable objects. The other disadvantage of contact scanners is that they are generally slow compared to the other scanning methods. Physically moving the articulating arm that the probe is mounted on can be slow and tedious.

There are generally two types of non-contact scanners: active and passive. Active scanners emit some form of radiation and detect its reflection in order to probe an object. Possible types of radiation used include light, ultrasound or x-ray. Passive scanners, on the other hand, do not emit any kind of radiation themselves. Instead, passive scanners rely on detecting reflected ambient radiation, typically in the visible light portion of the spectrum.

Photogrammetry is an example of a measuring technique utilizing a passive scanner in the form of a digital camera. In photogrammetry, the three-dimensional coordinates of points on the object are determined by measurements made in two or more photographic images taken from different positions. Common points are identified on each image. A line of sight or ray can then be constructed from the camera location to the point on the object. The intersection or triangulation of these rays determines the three-dimensional location of the point. Photogrammetry is particularly useful in extracting data relating to the position of points along the outer surface of the scanned object, but provides very limited information about the outer surface itself.

Laser surface scanning is well known for scanning the outer surface of the object. Laser scanners, or other similar surface scanners, are useful in providing data on the outer surface of the object, but are not well suited for extracting point or edge data from the object.

The shortcomings of these scanning methods can be overcome by combining the data provided by each, thereby gaining the advantages of both technologies. Thus, it remains desirable to provide a tool that facilitates combining the data from photogrammetric and surface scanning techniques and a method for the use of such a tool in the field.

### SUMMARY OF THE INVENTION

According to one aspect of the invention, a digitizer adapter assembly includes an attachment structure and a target. The attachment structure is configured to be removably coupled to an outer surface of an object to be scanned. The target is fixedly secured to the attachment structure. The target has a plurality of facets each having a contrasting mark. The plurality of facets are arranged in a generally polyhedral shape to facilitate scanning of the object from a plurality of vantage points.

### BRIEF DESCRIPTION OF THE DRAWINGS

Advantages of the present invention will be readily appreciated as the same becomes better understood by reference to the following detailed description when considered in connection with the accompanying drawing, wherein:

FIG. 1 is a perspective view of a digitizer adapter according to the invention;

FIG. 2 is a perspective view of digitizer adapters of FIG. 1 shown mounted to an object to be scanned;

FIG. 3 is a perspective view of the digitizer adapter according to a second embodiment of the invention; and

FIG. 4 is a perspective view of the digitizer adapter according to a third embodiment of the invention.

### DETAILED DESCRIPTION OF THE INVENTION

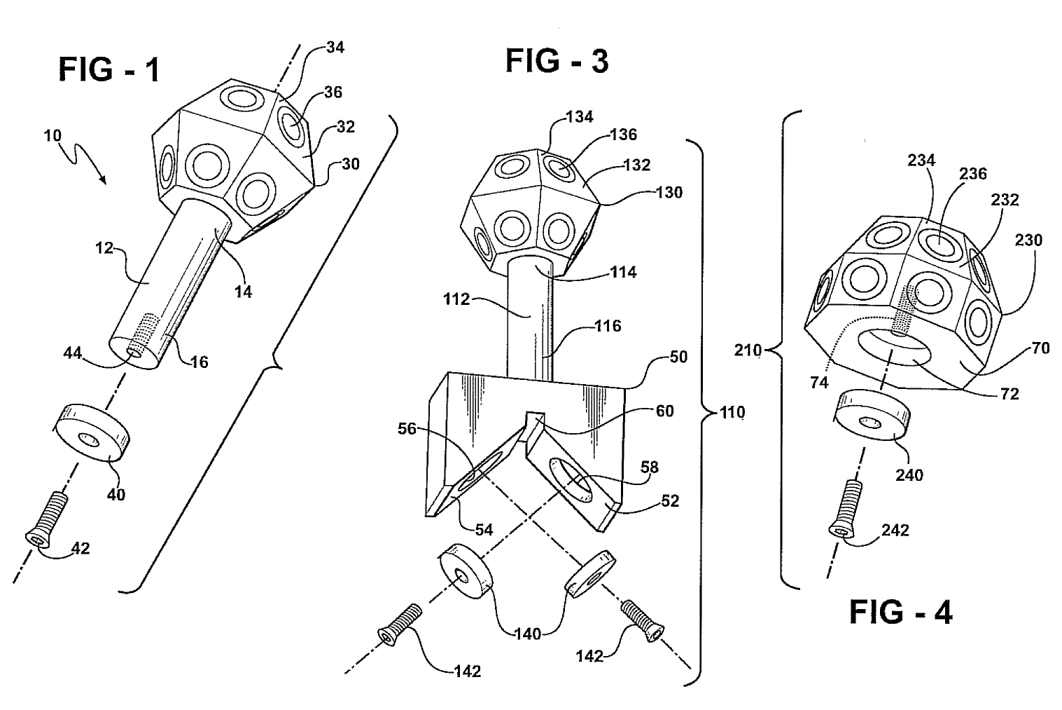

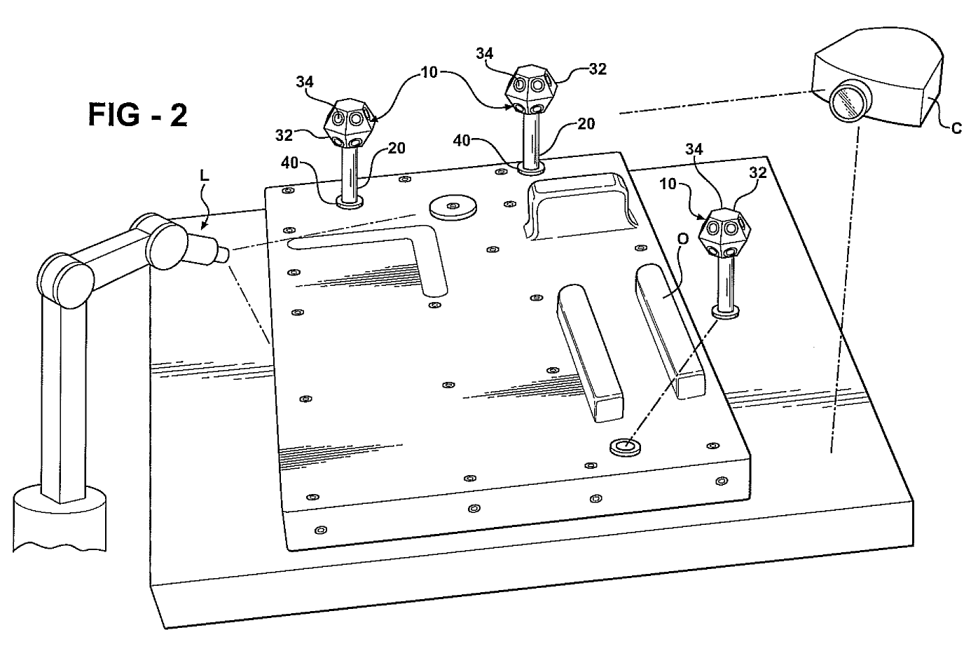

Referring to FIG. 1, a digitizer adapter assembly according to one embodiment is generally indicated at 10. The adapter assembly 10 includes a stem 12 extending between opposite ends 14, 16 along a longitudinal axis. One end 14 of the stem 12 is fixedly secured to a target 30. The other end 16 includes an attachment structure for attaching the adapter assembly 10 to an object to be measured by scanning.

The target 30 includes a plurality of facets 32 arranged in a generally polyhedral shape. Each facet 32 has a generally planar surface 34 and a mark 36 placed on the surface. The mark 36 is in the form of a circular dot. The surface 34 and mark 36 are colored to have high contrast relative to each other. For example, the surface 34 may be black and the mark 36 may be white. The mark 36 may be painted or provided as a sticker applied onto the surface 34 of the facet 32.

The attachment structure is provided in the form of a magnetic mounting ring 40 fixedly secured to the end 16 of the stem 12. Specifically, a bolt 42 extends through the mounting ring 40 and is threaded into a bore 44 formed at the end 16 of the stem 12. The mounting ring 40 allows the adapter assembly 10 to be held on a surface of a ferrous object to be scanned. Optionally, the magnet may be provided in other shapes, such as spherical, semi-spherical and square.

The adapter assembly 10 in this embodiment is particularly useful in the measurement of generally flat objects. The stern 12 elevates the height of the target 30 relative to a flat surface of the object, which increases variation in height among the plurality of targets 30. The increased variation in the height of the targets results in an increase in the overall accuracy of the scan of the object.

In use, at least three adapter assemblies 10 are used in a scan of a surface of an object to be measured. The mounting ring 40 for each adapter assembly 10 can be magnetically mounted to any desired surface along the object O if the object O or surface thereof is made from a ferrous material. It should, however, be readily appreciated by those skilled in the art that the mounting ring 40 may be mounted to non-ferrous materials using conventional fixing means, such as adhesives or clamps.

The object O may be digitized using any conventional scanning process, such as photogrammetry, laser scanning or white light surface scanning. The image is scanned by a scanning device, such as a camera C and/or laser L depending on the process being utilized. The scan information is received by a computer loaded with conventional scan processing software provided illustratively by Gesellschaft für Optische Messtechnik (GOM) mbH located in Braunschweig, Germany. The computer generates coordinates or point data corresponding to the marks 36 on each target 30. The location of each mark 36 relative to a predetermined reference point on the mounting ring 40 has been previously calculated and stored in the computer. The scanned point data is then aligned with the stored location data on the computer to determine the location of the reference points of each adapter assembly 10 in the reference frame in which the object O is being scanned. At least three reference points defines the digitized scanned flat surface of the object O. The three dimensional multi-faceted shape of the target 30 increases the number of marks 36 that can be seen by the scanning device for any given angle of incidence, thereby facilitating the scanning process by minimizing the time taken to reposition targets and/or scanning devices when changing scanning vantage points.

Referring to FIG. 3, a second embodiment of the adapter assembly is generally indicated at 110. The adapter assembly 110 in this embodiment includes an attachment structure in the form of a block 50 with a pair of locating surfaces 52, 54 that are generally orthogonal to each other that allows the assembly 110 to be located and mounted along a corner of an object to be measured. At least one of the locating surfaces 52, 54 includes a recess 56, 58 that receives the magnetic mounting ring 140 therein. A threaded hole is formed at the bottom of each recess 56, 58 that allows the ring 140 to be secured to the block 50 using a bolt 142. The locating surfaces 52, 54 are generally planar and intersect at a cutout 60. The cutout 60 receives therein a corner of the object be measured to ensure that the locating surfaces 52, 54 fully seated and located against respective surfaces of the object to be measured.

Referring to FIG. 4, a third embodiment of the adapter assembly is generally indicated at 210. The adapter assembly 210 in this embodiment lacks the stem 12 from the first embodiment. Instead, a recess 72 is formed along a bottom surface 70 of the target 230. The recess 72 receives the mounting ring 40 therein. A threaded bore 74 is formed at the bottom of the recess 72 for fixedly securing the mounting ring 40 to the target 230 with a bolt 242.

The invention has been described in an illustrative manner. It is, therefore, to be understood that the terminology used is intended to be in the nature of words of description rather than of limitation. Many modifications and variations of the invention are possible in light of the above teachings. It should, therefore, be readily apparent that the invention may be practiced other than as specifically described, while remaining within the scope of the appended claims.

I claim:

1. A digitizer adapter assembly comprising:
an attachment structure configured to be removably coupled to an outer surface of an object to be scanned; and
a target fixedly secured to the attachment structure, the target having a plurality of facets each having a contrasting mark, the plurality of facets being arranged in a generally polyhedral shape to facilitate scanning of the object from a plurality of vantage points.

2. A digitizer adapter assembly as set forth in claim 1 including a step that extends longitudinally between the attachment structure and the target.

3. A digitizer adapter assembly as set forth in claim 1, wherein attachment structure includes a magnet that allows the digitizer adapter assembly to be secured along a ferrous surface.

4. A digitizer adapter assembly as set forth in claim 3, wherein the magnet is annular shaped and secured to the digitizer adapter assembly using a bolt.

5. A digitizer adapter assembly as set forth in 1, wherein the attachment structure includes a pair of locating surfaces that are orthogonal relative to each other to allow the digitizer adapter assembly to be located along a corner of an object to be measured.

6. A digitizer adapter assembly as set forth in claim 5, wherein the locating surfaces are generally planar and intersect at a cutout that receives therein a corner of the object to be scanned to ensure that the locating surfaces are located against respective surfaces of the object.

7. A digitizer adapter assembly as set forth in claim 6, wherein the cutout has a generally square cross section.

8. A digitizer adapter assembly as set forth in claim 5, wherein at least one of the locating surfaces includes a recess that receives a magnet therein that allows the digitizer adapter assembly to be secured along a ferrous surface.

9. A digitizer adapter assembly as set forth in claim 8, wherein the magnet is annular shaped and secured to the digitizer adapter assembly using a bolt.

10. A digitizer adapter assembly as set forth in 1, wherein the target includes a recess formed in a surface thereof for receiving a magnet therein that allows the digitizer adapter assembly to be secured along a ferrous surface.

11. A digitizer adapter assembly as set forth in claim 10, wherein the magnet is annular shaped and secured to the digitizer adapter assembly using a bolt.
